(19) United States
(12) Patent Application Publication
(10) Pub. No.: US 2013/0154368 A1
(43) Pub. Date: Jun. 20, 2013

(54) Converter-based Power Supply System for Reducing a Contract Capacity

(71) Applicants: Zen-Shan Chang, Taoyuan County (TW); Kuo-Kuang Jen, Taoyuan County (TW)

(72) Inventors: Zen-Shan Chang, Taoyuan County (TW); Kuo-Kuang Jen, Taoyuan County (TW)

(73) Assignee: Chung-Shan Institute of Science and Technology Armaments, Bureau, Ministry of Natonal Defense, Taoyuan County (TW)

(21) Appl. No.: 13/328,216

(22) Filed: Dec. 16, 2011

(51) Int. Cl. H02J 4/00

(52) U.S. Cl. 307/26

(57) ABSTRACT

Disclosed is a converter-based power supply system. The converter-based power supply system includes a power supply controller, a first meter connected to the power supply controller, an alternating current load connected to the first meter, a second meter connected to the power supply controller, a grid connected to the second meter, converters connected to the alternating current load and the grid, and an energy storage unit connected to the power supply controller and the converters.

### BACKGROUND OF INVENTION

1. Field of Invention

The present invention relates to a power supply system and, more particularly, to a converter-based power supply system for reducing a contract capacity.

2. Related Prior Art

In the 21^{st} century, information and green energy are two important fields in the development of the technology. Regarding the green energy, the design, analysis and application of converters of large-scale storage units are essential. Power electronics is a core technology. The power electronics covers a wide range of designs and applications and exhibits the nature of the integration of technologies. The power electronics is the foundation for the automation industry, defense industry, aerospace industry, transportation industry and environmental protection industry.

A converter power supply system that includes a power supply controller in combination with an energy storage unit effectively reduces a peak contract capacity of a factory or entrepreneur. Via an RS485 interface, a programmable two-way converter power supply system advantageously uses a meter to measure a variable need of an alternating current load and the state of work of a converter and send the data to the power supply controller. According to the power needed, the controller sends a Charger-or-Discharger command to the energy storage unit, and this is useful in reducing the cost of the purchase of a reserve margin system and the cost of the supply of the electricity.

Conventionally, converters are combined with DC/DC converters, and the converters are used as controllable alternating current generators. Actual and virtual powers are sent to the grid under the control of the converters. As shown in FIG. 4, as stated in IEEE Energy 2030 Atlanta, Ga. USA 17-18 Nov. 2008, a conventional converter power supply system includes an energy-source converter controller 6, converters 7, bus voltages 8 and an alternating current load 9. The energy-source converter controller 6 is connected in the form of an alternating current net. The converter 7 provides an amplitude and phase for controlling an output voltage. The bus voltages 8 are provided from various green energy sources. The converter voltage together with the grid or micro-grid determines the travel of the actual and virtual powers to the micro-grid or grid from the energy-source. The actual and virtual powers are used to control and adjust the output voltage and phase of the converter 7 and travel in the micro-grid power supply system via the energy-source converter controller 6 and the converter 7.

Regarding the prior art as shown in FIG. 4, attention should be paid to things as follows:

At first, due to the difference between on-grid and off-grid operations of the micro-grid and the existence of the energy storage unit, energy travels in various directions in the micro-grid. Hence, the most important thing is to build the optimum synchronization protection of the on-grid and off-grid operations.

Secondly, according to the needs of the load, sensitive or non-sensitive, a grid dispatch strategy is modified to cope with various events that occur in the operation of the grid. The modification and operative conditions are recorded. Attention has to be paid to integration and test of various dispatch strategies.

Thirdly, for a sub-grid dispatching system, the feasibility of integrated operation of a simulated power system and a dispatch control strategy is analyzed. Influences of various parameters on the grid voltage are analyzed. The economic aspect, the stability and the system reliability are some examples of the parameters.

The foregoing things should be noted in the test of a multi-converter feed-in grid. Attention must be paid to the integration and test of the dispatch strategies. Recently, the distributed generating technology has been emerging thanks to the oil crisis. That is, a transmission and distribution grid is an independent generation system for energizing critical loads. In this case, a power condition unit (“PCU”) exchanges energy with an external grid. It is however difficult to satisfy needs of the power quality and power supply safety. Because of the united energy storage units, needs of an external transmission and distribution grid must be satisfied within seconds. The optimum synchronization protection of the operations must be built. According to the needs of the load, the grid dispatch strategy is modified based on the events that occur in the grid. The modification of the parameters is recorded. Thus, the energy conversion of the power regulation unit is achieved. There are however challenges for the control over the DC link voltage of the converter and the balance of the powers.

The present invention is therefore intended to obviate or at least alleviate the problems encountered in prior art.

### SUMMARY OF INVENTION

It is the primary objective of the present invention to provide a converter-based power supply system.

To achieve the foregoing objective, the converter-based power supply system includes a power supply controller, a first meter connected to the power supply controller, an alternating current load connected to the first meter, a second meter connected to the power supply controller, a grid connected to the second meter, converters connected to the alternating current load and the grid, and an energy storage unit connected to the power supply controller and the converters.

In an aspect, the first meter is connected to power supply controller via an RS485 interface.

In another aspect, the second meter is connected to the power supply controller via an RS485 interface.

In another aspect, the converters are 5 W converters.

In another aspect, the converters are connected to the alternating current load and the grid via an alternating current bus.

In another aspect, each of the converters includes a full bridge converter, a gate driver, a microprocessor, a current sensor, a current feedback unit, a grid differential transformer, a zero-voltage cross-over sensor, a direct current transformer and a direct current feedback unit connected to one another.

In another aspect, the full bridge converter includes at least four power switches.

In another aspect, the power switches are IGBT power switches (TA+, TA−, TB+, TB−).

In another aspect, the energy storage unit is 360V Li-H battery.

In another aspect, the energy storage unit is connected to the power supply controller and the converters via a direct current bus.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a block diagram of an electricity control system for reducing a contract capacity according to the preferred embodiment of the present invention;

FIG. 2 is a block diagram of a converter array of the electricity control system shown in FIG. 1;

FIG. 3 is a flow chart of a method for operating the electricity control system shown in FIG. 1; and

FIG. 4 is a block diagram of a conventional electricity control system.

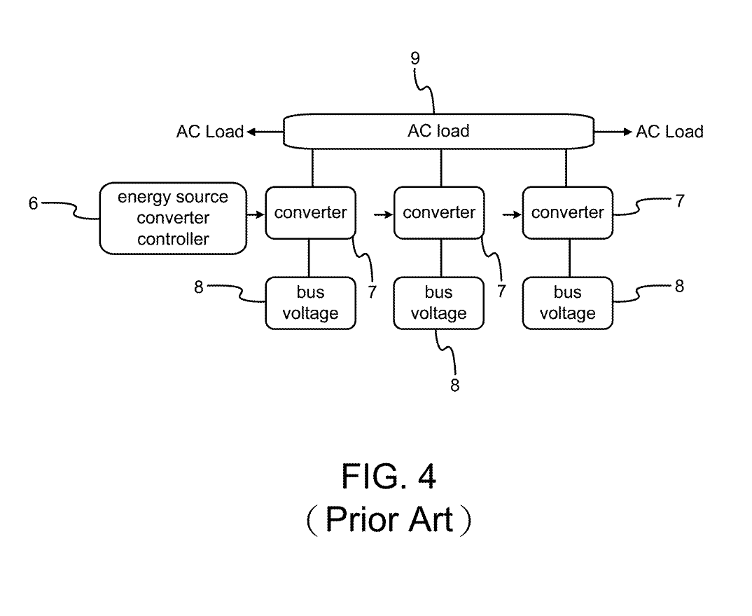

### DETAILED DESCRIPTION OF PREFERRED EMBODIMENT

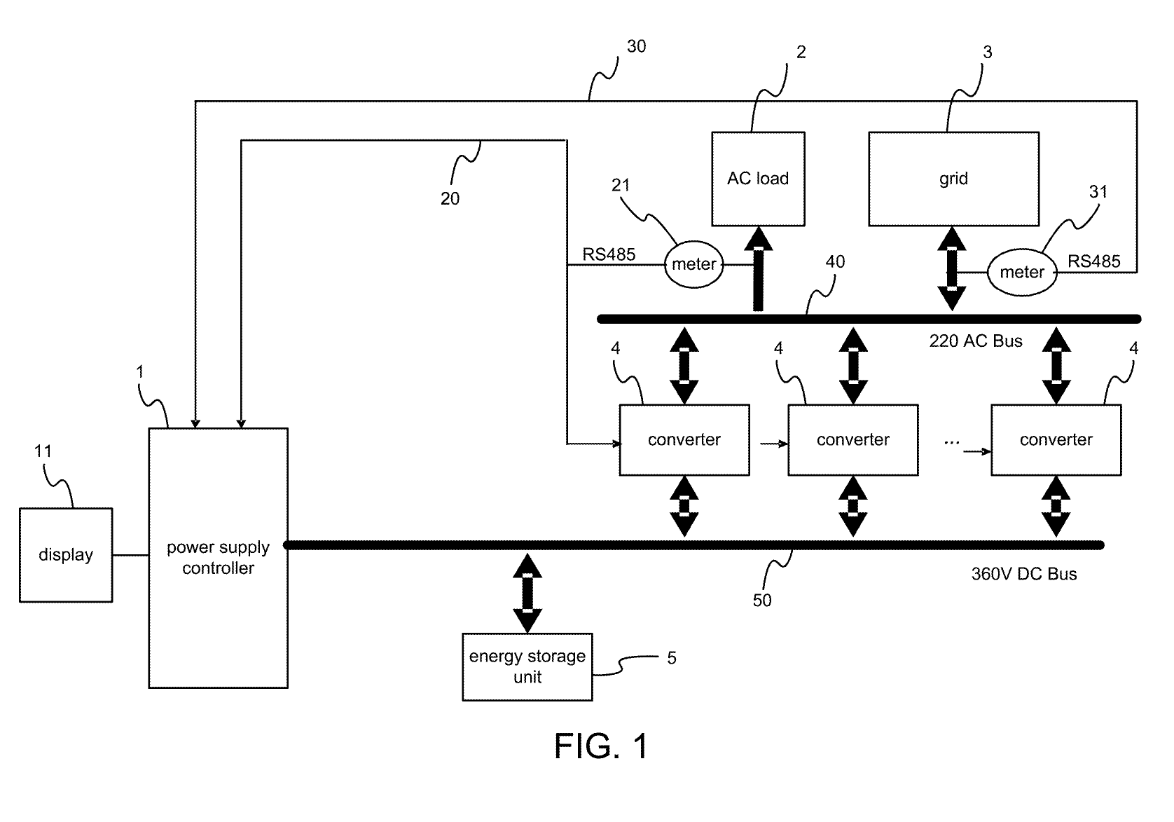

Referring to FIG. 1, there is shown a converter-based power supply system according to the preferred embodiment of the present invention. The converter-based power supply system includes a power supply controller 1, an alternating current load 2, a grid 3, an array of converters 4 and an energy storage unit 5.

The power supply controller 1 is equipped with a display 11.

the alternating current load 2 is connected to the power supply controller 1 via a meter 21. The meter 21 is connected to the power supply controller 1 via an RS485 interface 20.

The grid 3 is connected to the power supply controller 1 via a meter 31. The meter 31 is connected to the power supply controller 1 via an RS485 interface 30.

The converters 4 are connected to the alternating current load 2 and the grid 3 via an alternating current bus 40. Each converter 4 may be a 5 W converter.

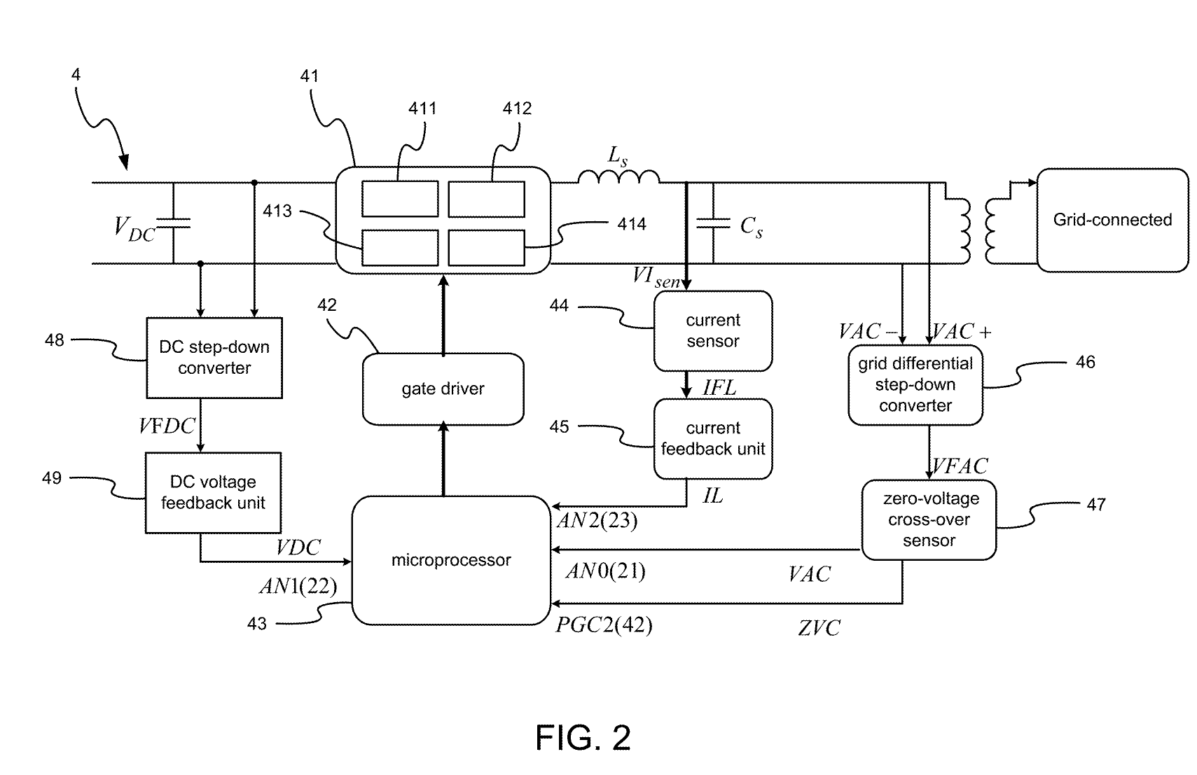

Referring to FIG. 2, each converter 4 includes a full bridge converter 41, a gate driver 42, a microprocessor 43, a current sensor 44, a current feedback unit 45, a grid differential transformer 46, a zero-voltage cross-over sensor 47, a direct current step-down converter 48 and a direct current feedback unit 49.

The elements 41 to 49 are connected to one another. The full bridge converter 41 includes at least four power switches 411, 412, 413 and 414. The power switches may be IGBT power switches (TA+, TA−, TB+, TB−).

The energy storage unit 5 is connected to the power supply controller 1 and the converters 4 via a direct current bus 50. The energy storage unit 5 may be a 360V Li-H battery.

In operation, the meters 21 and 31 measure the variable demand from the alternating current load 2, off-peak and peak rates of the grid 3, on-grid or off-grid, the voltage and current of the converter 4, and whether the direct current bus 50 is retained at 360V, and controls and predicts the operation of the energy storage unit 5. The RS485 interfaces 20 and 30 send data to the power supply controller 1, and the data are shown on the display 11. The power supply controller 1 collects, analyzes and screens all of the data to determine whether there is any error. Based on the data, the power supply controller 1 commands the converters 4 to control the power of the power supply system. The converters 4 provide the state and the amplitude of the current of the grid 3, and exhibits protective modes against over-voltage, under-voltage, over-current and over-heat. Thus, the converter-based power supply system is able to store, discharge and be charged with various direct currents, and provides the optimal management for off-grid and on-grid modes when there is inadequate energy in the energy storage unit 5.

The meter 21 measures the variable demand from the alternating current load 25 and the voltages and currents of the converters 4. The RS485 interface 20 sends the data to the power supply controller 1 to execute a power-factor modifying mode. That is, the power supply controller 1 charges the energy storage unit 5 and controls the energy in the energy storage unit 5.

In emergency such as failure of the grid 3 or at a peak of consumption, the energy storage unit 5 provides electricity. Hence, a contractor capacity of a consumer can be reduced.

Moreover, each converter 4 is operated as follows:

The converter 4 enters a buying mode. The voltage of the direct current bus 50 is retained at 360 volts. At the direct current input end, there is voltage variation when a regulating electrolytic capacitor reduces the power. The full bridge converter 41, which includes the power switches 411, 412, 413, 414, uses sine-wave PWM signal-switching. The high-frequency PWM signal is filtered, and there is therefore provided a low-frequency current at 60 Hz. The current sensor 44 catches the output inductance and current, and accordingly provides a voltage signal. The current feedback unit 45 completes the full-wave rectification. The voltage signal is sent to the microprocessor 43 which executes calculation based on the voltage signal for control and protection against over-current.

The grid differential transformer 46 reduces the voltage from the grid 3 to 5 volts or lower. The zero-voltage cross-over sensor 47 completes the full-wave rectification and a comparator-output square-wave (zero-voltage cross-over) signal. The zero-voltage cross-over signal is sent to the microprocessor 43 that executes calculation based on the zero-voltage cross-over signal for control and protection against over-pressure.

Similarly, the direct current step-down converter 48 reduces the voltage from the bus voltage to 5 volts or lower. The direct current feedback unit 49 completes error compensation and a corresponding voltage signal to the microprocessor 43 which executes calculation based on the voltage signal for keeping the voltage of the direct current bus 50 at 360 volts and preventing the bus voltage from over-voltage. Then, signals related to the feedback inductance current, the voltage from the grid 30, the zero-voltage cross-over and the feedback DC voltage to the microprocessor 43. In compliance with the Predictive Current Control Theory, the maximum and minimum values of the PWM of the power switches 411, 412, 413, 414 of the full bridge converter 41 are calculated, and sent from the microprocessor 43 to the gate driver 42 (driver circuit). The states of the power switches of the converter 4 are used to complete the control over the current in the on-grid mode or the power-factor modified mode.

The operation of the converter-based power supply system is operated in a digital manner. The output current and the input and output voltages are measured for n periods of the converter. The measured data are calculated in a mathematical model of the converter to predict the state of switching of the power switches for n+1 periods.

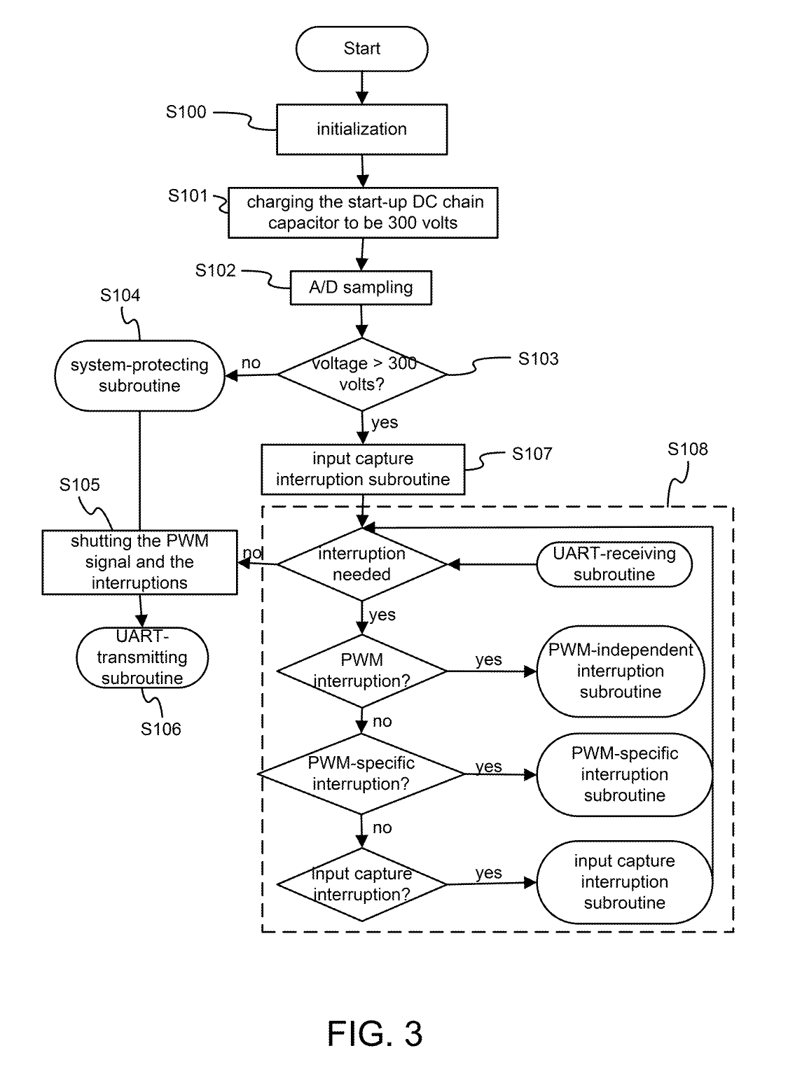

Referring to FIG. 3, at S100, the microprocessor 43 is initialized. That is, the interruption subroutine, A/D module, UART circuit and PWM module are initialized. Now, a relay of the grid 3 is turned on to send the grid voltage signal to the microprocessor 43.

At, S101, on the side of the grid 3, a start-up direct current chain capacitor is charged so that it reaches 300 volts.

At S102, A/D sampling is executed.

At S103 it is determined whether the voltage is higher than 300 volts. The process goes to S104 if the voltage is lower than 300 volts. The process goes to S107 if the voltage is higher than 290 volts.

At S104, the system-protecting subroutine is initiated. Protection against abnormal direct current chain voltage is initiated. Then, the process goes to S105.

At S105, the PWM and any interruption are shut. Then, the process goes to S106.

At S106, the UART-transmitting subroutine is executed.

At S107, an input capture interruption subroutine is started.

If there is no need for interruption, the process goes to S105 to shut the PWM signal and any interruption. Then, the process goes to S106 to initiate the UART-transmitting subroutine. If there is any need for interruption, the process goes to S108, and the data such as the voltage, current, power, temperature and BMS of the controller are checked. If there is any error in the data, the PWM duty of the converter is turned off to preventing the power supply system from burning. The input capture interruption subroutine shuts the PWM interruption to prevent the PWM interruption subroutine from interrupting the input capture interruption subroutine. Then, a 50.8 us counter is used to determine whether the frequency of the grid 3 is normal. If the frequency of the grid 3 is normal, all of the PWM signals are shut.

In accordance with the present invention, the power supply controller 1 collects various data and technologies including the peak and off-peak rates of the grid 3 and the on-grid and off-grid modes, the state of the converter, the performance of the equipment, the control and prediction of the load. Then, the power supply controller 1 analyzes the data, and sends corresponding commands via the RS485 interface 20. The collection and processing of the data are important. The converter-based power supply system of the present invention exhibits at least the following advantages:

At first, on demand from the load or the system, the converter-based power supply system based on the Predictive Current Control Theory and the

Sine Wave PWM Theory, the current-feedback manner is used to complete two-way dynamic regulation of the current to satisfy the dynamic demands.

Secondly, the RS485 protocol is used to coordinate the control over the energy by the converter power supply system. Based on the demand from the load, the rates of the grid, and whether the grid is normal, the voltage and current and their data are provided and shown so that the operation of the converters can be understood.

Thirdly, the converter-based power supply controller is used for economical dispatching. The energy storage unit is charged or made to discharge. Based on the demand for the energy, the command for the on-grid or power-factor modified mode are given to reduce the contract capacity at the peak rate.

The converter-based power supply system overcomes the problems with the prior art. Various direct currents can be stored in and released from the energy storage unit. The management of the off-grid and on-grid power is optimized. When the energy in the energy storage unit is inadequate, the power supply controller executes the power-factor modification to charge and control the energy stored in the energy storage unit. In emergency such as failure of the grid or at a peak of consumption, the energy storage unit stratifies the need of the load. Thus, the contract capacity can be reduced.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A converter-based power supply system including:
a power supply controller;
a first meter connected to the power supply controller;
an alternating current load connected to the first meter;
a second meter connected to the power supply controller;
a grid connected to the second meter;
converters connected to the alternating current load and the grid; and
an energy storage unit connected to the power supply controller and the converters.

2. The converter-based power supply system according to claim 1, wherein the first meter is connected to power supply controller via an RS485 interface.

3. The converter-based power supply system according to claim 1, wherein the second meter is connected to the power supply controller via an RS485 interface.

4. The converter-based power supply system according to claim 1, wherein the converters are 5 W converters.

5. The converter-based power supply system according to claim 1, wherein the converters are connected to the alternating current load and the grid via an alternating current bus.

6. The converter-based power supply system according to claim 1, wherein each of the converters includes a full bridge converter, a gate driver, a microprocessor, a current sensor, a current feedback unit, a grid differential transformer, a zero-voltage cross-over sensor, a direct current transformer and a direct current feedback unit connected to one another.

7. The converter-based power supply system according to claim 6, wherein the full bridge converter includes at least four power switches.

8. The converter-based power supply system according to claim 7, wherein the power switches are IGBT power switches (TA+, TA−, TB+, TB−).

9. The converter-based power supply system according to claim 1, wherein the energy storage unit is 360V Li-H battery.

10. The converter-based power supply system according to claim 1, wherein the energy storage unit is connected to the power supply controller and the converters via a direct current bus.
